(19) United States
(12) Patent Application Publication
(10) Pub. No.: US 2012/0100305 A1
(43) Pub. Date: Apr. 26, 2012

(54) METHOD OF FABRICATING A PART DECORATED WITH RELIEF

(75) Inventor: Juliette Muller, La Neuveville (CH)

(73) Assignee: ETA SA MANUFACTURE HORLOGERE SUISSE, Grenchen (CH)

(21) Appl. No.: 13/378,833

(22) PCT Filed: Jun. 25, 2010
(86) PCT No.: PCT/EP2010/059085

§ 371 Date: Dec. 16, 2011

(30) Foreign Application Priority Data
Jul. 6, 2009 (EP) 09164688.5

(51) Int. Cl. B05D 3/06; B05D 3/12; B05D 5/00

(52) U.S. Cl. 427/555; 427/271; 427/275

(57) ABSTRACT

A method for fabricating a part with relief, wherein portions in relief are at least partially coated with a decorative layer. The method a) forms the body of the part; b) selectively alters the surface state of the body of the part to change the adherence thereof locally relative to the decorative layer; c) directly deposits the decorative layer over the entire body; d) removes the portions of the deposited layer which have not adhered to the body of the part. The method can be utilized in decorating timepieces.

### FIELD OF THE INVENTION

The invention relates to a method for fabricating a part decorated with relief and, more specifically, a plastic part whose decorations have a metallic appearance.

### BACKGROUND OF THE INVENTION

A timepiece dial usually includes appliques for decorating the dial. These appliques may, for example, represent an hour circle to facilitate determination of the time relative to the position of the timepiece hands.

These appliques may also simply be used to give the dial an attractive appearance.

Usually, these appliques are assembled on the dial by a series of bonding, then possibly masking and/or buffing steps, which, in addition to the cost of the appliques, lead to excessive fabrication costs due to the positioning precision required, which increases with the thickness of the applique.

### SUMMARY OF THE INVENTION

It is an object of the present invention to overcome all of part of aforecited drawbacks by proposing, more generally, a method for fabricating a decorated part which has fewer steps and uses less material to make the decorations.

The invention therefore relates to a method for fabricating a part with relief, wherein said portions in relief are at least partially coated with a decorative layer, including the following step:

a) forming the body of the part;

characterized in that the method further includes the following steps:

b) selectively modifying the surface state of the body of the part in order to change the adherence thereof locally relative to said decorative layer;

c) directly depositing said decorative layer over the entire body;

d) removing the portions of the deposited layer which have not adhered to the body of the part.

Advantageously according to the invention, it is thus clear that it is no longer necessary to selectively deposit the decorations. The prior structuring operation allows the adhesion and/or non adhesion areas to be precisely selected in order to simplify the step of depositing the decoration(s).

In accordance with other advantageous features of the invention:

Step b) is for locally reducing the adherence of the surface of the body so that, in step c), the deposited layer does not adhere to the altered portions;

The reduction in adherence is obtained by forming bosses alternately with hollows, the height and width of the hollows being respectively comprised between 50 and 200 μm, and 5 and 10 μm, and the width of the bosses between 0.1 and 3 μm;

Step b) is for locally increasing the adherence of the surface of the body so that, in step c), the deposited layer adheres to the altered portions;

The increased adherence is obtained by forming bosses alternately with hollows, the height and the width of the hollows being respectively comprised between 2 and 10 μm and 5 and 20 μm, and the width of the bosses between 5 and 20 μm;

The widths of the hollows and the bosses are substantially equal;

Step a) is achieved by injecting material into a mould;

Steps a) and b) are performed at the same time by locally altering the internal surface state of said mould;

Step b) is performed by laser type radiation;

Step c) is achieved by vapour phase deposition;

The decorative layer includes at least one metallic material;

After step d), galvanoplasty is performed in order to thicken each portion including said decorative layer;

The body of the part is made using a plastic material;

The part with relief is a timepiece dial.

### BRIEF DESCRIPTION OF THE DRAWINGS

Other features and advantages will appear clearly from the following description, given by way of non-limiting indication, with reference to the annexed drawings, in which:

FIG. 1 is a typical timepiece dial seen from above;

FIG. 2 is a schematic cross-section along line A-A of FIG. 1;

FIGS. 3 to 7 are diagrams of successive steps of two embodiments of the fabrication method according to the invention;

FIG. 8 is a flow diagram of the fabrication method according to the invention;

FIG. 9 is a schematic top view of a dial according to the invention;

FIG. 10 is an enlarged diagram of one part of FIG. 9 according to a first embodiment;

FIG. 11 is a cross-section A-A of FIG. 10;

FIG. 12 is an enlarged diagram of one part of FIG. 9 according to a second embodiment;

FIG. 13 is a cross-section B-B of FIG. 12.

### DETAILED DESCRIPTION OF PREFERRED EMBODIMENTS

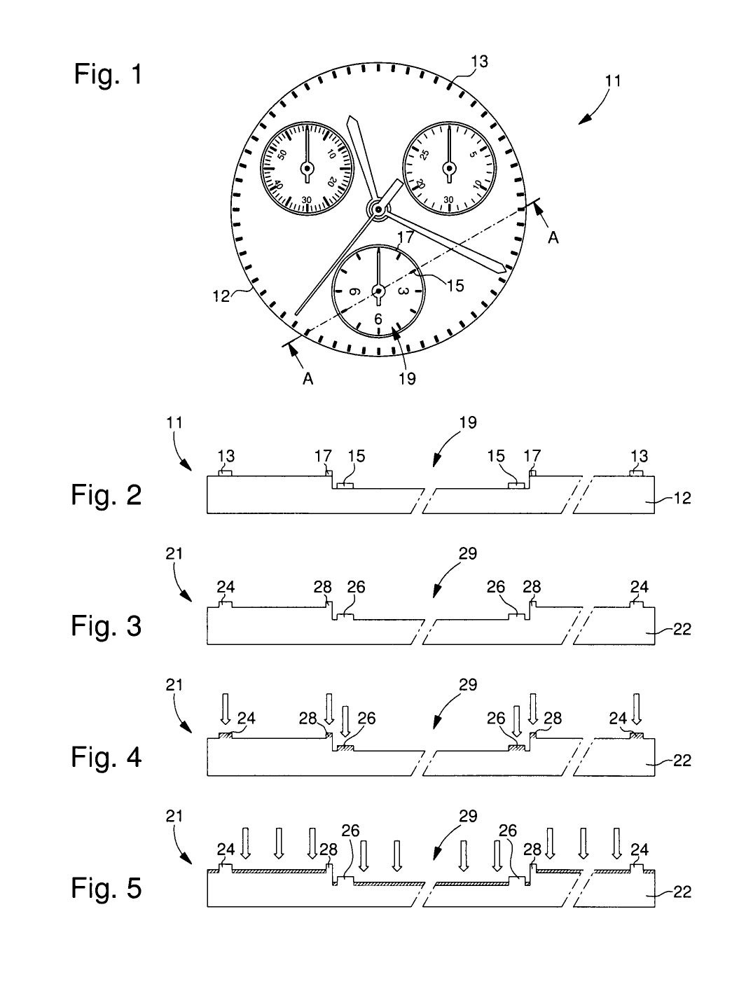

FIGS. 1 and 2 show a typical dial 11 for a timepiece. As explained hereinbefore, method 1 according to the invention is not limited to the fabrication of a dial but applies to any type of plastic part decorated with relief. However, a timepiece dial is a good example of the application of method 1 according to the invention.

As seen in FIGS. 1 and 2, a dial 11 is typically a body 12 with several levels. In the example illustrated in FIG. 2, it can be seen that the body 12 includes, in particular, a circular recess 19 able to form a secondary display of the timepiece. It is also noted that the top face of body 12 includes an hour circle in the form of regularly spaced hour symbols 13. Likewise, the secondary display includes a second series of hour symbols 15 around said circular shape. Finally, the top surface includes a decoration 17 for concealing the shoulder between said top surface and recess 19.

As explained hereinbefore, to make this dial 11, these hour symbols 13, 15 and decoration 17 have to be added by successive bonding, then possibly masking and/or buffing steps when the relief is very pronounced. Advantageously according to the invention, fabrication method 1 provides a new type of fabrication which is particularly suited to plastic parts 21, which have very pronounced relief, i.e. higher than 40 μm.

As illustrated in FIG. 8, fabrication method 1 includes a first step 3 for fabricating the main body 22 of the future plastic part 21 (a dial 21 in the example hereinbelow). Preferably, step 3 is achieved by injecting said plastic material into a mould (not shown). Indeed, this type of fabrication makes it possible to produce precise blanks of the relief portions of dial 21.

The example illustrated in FIG. 3 clearly shows the raised locations 24, 26 and 28, intended to form respectively the future hour symbols 23, 25 and decoration 27. The hollow portion 29 intended to form the secondary display can also be seen. It is thus clear that in a single step 3, the positioning of the various portions of dial 21 is very precisely achieved. According to the invention, the plastic material for making body 22 may be, for example, thermoplastic resins such as Styrenics, like Acrylonitrile Butadiene Styrene (ABS), acrylic resins like Poly(methyl methacrylate) (PMMA) and mixtures like PMMA/ABS, polyesters like Polyethylene Terephtalate (PET), Polybutylene Terephtalate (PBT), polyamides, Polycarbonates (PC), ABS/PC mixtures, an Ethylene vinyl acetate copolymer (EVA), polyimides or fluourinated resins such as Polytetrafluoroethylene (PTFE).

In a second step 5 of method 1, the surface of body 22 is structured so as to locally alter the surface state thereof. According to the invention, step 5 has two embodiments according to the adherence characteristics of the plastic material used. According to the invention, the decorative layer will be applied directly to the plastic body 22.

Thus, in a first embodiment in which the plastic material has a very low level of adherence relative to the decorative layer to be deposited, step 5, as illustrated in FIG. 4, is intended to locally increase the adherence of the surface of body 22 on the portions to be decorated, i.e. the raised portions 24, 26 and 28.

In the first embodiment, the very low adherence materials, called “not wetables” are, for example, but not exclusively, polyolefins (PE˜70%, PP˜60%, etc.), saturated polyesters (PET, PBT, etc.), polyamides (PA, etc.), fluoropolymers (PTFE>50%, etc.) or polyoxymethylenes (POM˜80%, etc.).

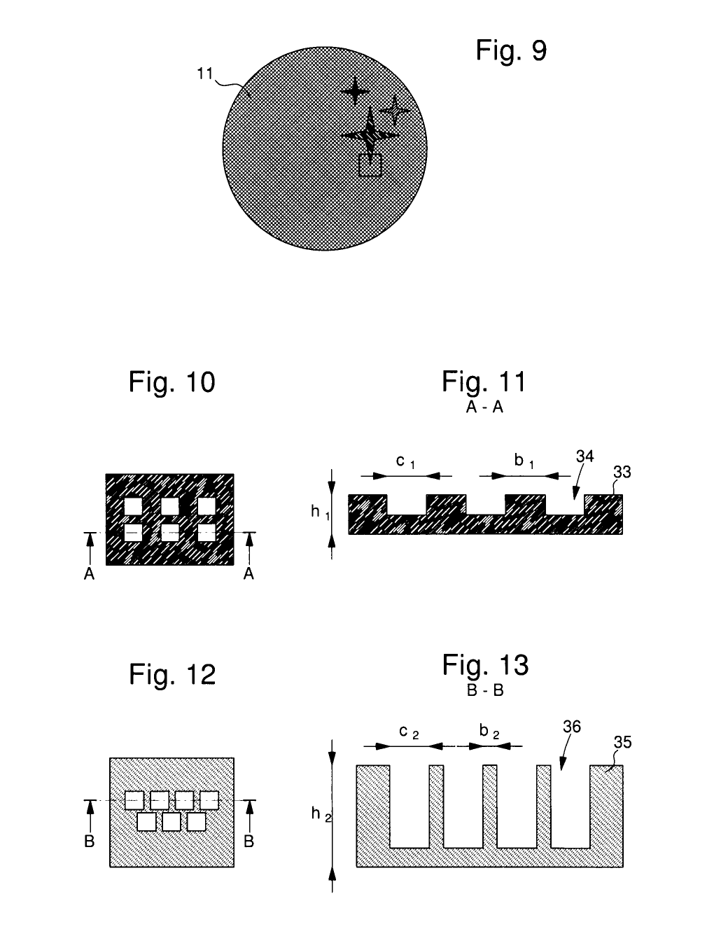

In this first embodiment seen in FIGS. 9 to 11, the structuring for increased adherence includes bosses 33 formed by making hollows 34 in the thickness of the part to be decorated 11, which is not limited to a dial. By way of example, the height h₁ of hollows 34 is low, i.e. comprised between 2 and 10 μm and preferably around 5 μm, the width c₁ of hollows 34 is comprised between 5 and 20 μm and preferably around 10 μm, and the width b₁ of bosses 33 is comprised between 5 and 20 μm and preferably around 10 μm.

Preferably, the widths c₁, b₁ of hollows 34 and bosses 33 respectively are substantially equal. This local structuring thus advantageously increases the selective adherence of the surface which will be coated in step 7.

Conversely, in a second embodiment in which the plastic material has good adherence relative to the decorative layer to be deposited, step 5, as illustrated in FIG. 5, is intended to locally decrease the adherence of the surface of body 22 on the portions which are not to be decorated, i.e. all of the portions except for raised portions 24, 24 and 28.

In the second embodiment, materials that adhere well, called “wetable” materials are, for example, but not exclusively, poly carbonates (PC, etc.), Styrenics (ABS, PS, etc.), polyacrylics (PMMA, MABS, etc.), aromatic polysulphones (PSU, etc.), aromatic polyamides (25% semi-crystalline PPA, amorphous PPA , etc.) or poly(aryl ether ketone)s (semi crystalline PEEK etc.).

In this second embodiment seen in FIGS. 9, 12 and 13, the adherence-reducing structuring includes bosses 35 formed by making hollows 36 in the thickness of the part to be decorated 11, which is not limited to a dial. By way of example, the height h₂ of hollows 36 is high, i.e. comprised between 50 and 200 μm and preferably around 100 μm, the width c₂ of hollows 36 is comprised between 5 and 20 μm and preferably around 10 μm, and the width b₂ of bosses 35 is small, i.e. comprised between 0.1 and 3 μm and preferably around 1 μm. This local structuring advantageously selectively decreases the adherence of the surface which will be coated in step 7.

Step 5 for selectively structuring the surface state of body 22 may be envisaged in a destructive or non-destructive manner. Indeed, according to a non-destructive alternative, the surface state could be “fabricated” at the same time as the body 22 itself, by “negatively” adapting the inner surface of the mould used in step 3. It is then clear that steps 3 and 5 would be performed at the same time.

However, step 5 for selectively structuring the surface state of body 22 may also be performed in a destructive manner in another alternative, i.e. by removing material. Preferably, in this other alternative, the structuring in step 5 is performed by laser type radiation which offers a very high level of precision for altering the surface state. Thus, body 22 may be removed from the mould and then subjected to said radiation, or, in a variant, the mould may comprise portions that are transparent to said radiation which allows said body to be structured “in situ”, i.e. without prior removal from the mould.

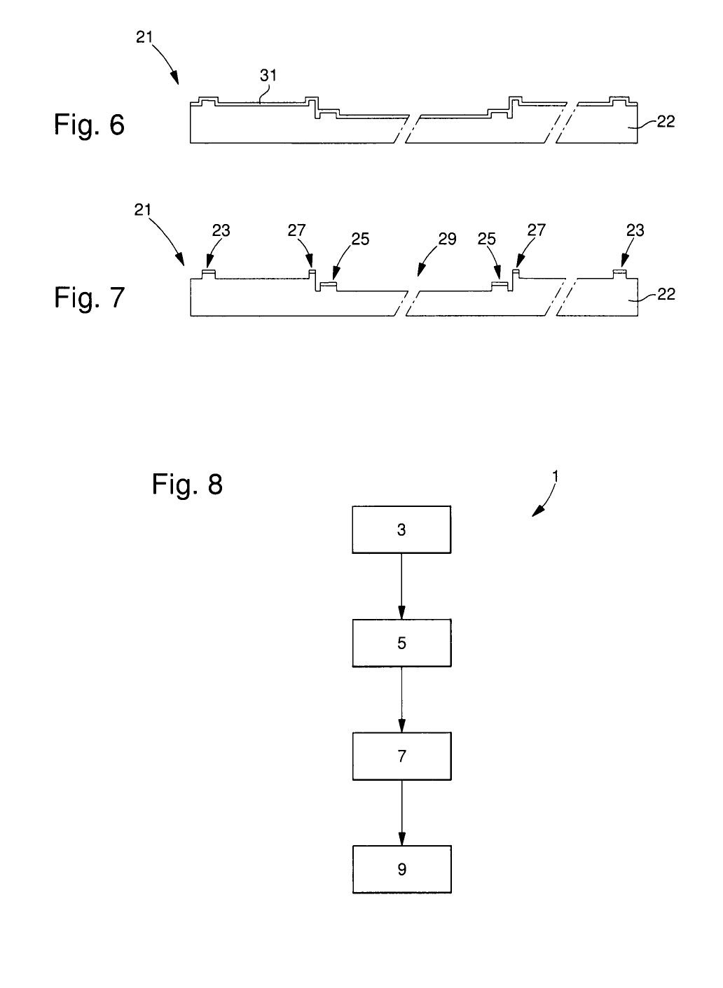

After the implementation of one of these two embodiments of step 5, the method 1 continues with a step 7 for depositing a decorative layer 31 over the entire body 22, as illustrated in FIG. 6. Preferably, step 7 is performed by physical vapour deposition (PVD). However, other types of deposition may be envisaged, such as galvanoplasty, chemical vapour deposition (CVD), atomic layer deposition (ALD) or even UV printing or lacquering.

Advantageously according to the invention, the last step 9 consists solely in removing the portions of the deposited layer 31 which have not adhered to body 22 of part 21. Indeed, owing to the structuring in one of the embodiments of step 5, the decorative layer 31 only remains, i.e. adheres, on hour symbols 23, 25 and decoration 27, as a result of step 9. Step 9 may, for example, be achieved by polishing, compressed air jet or by wet cleaning.

Preferably, the decorative layer 31 includes at least one metallic material, which allows dial 21 to offer a bright finish on the raised portions 23, 25 and 27 thereof. However, other types of materials can be envisaged, such as, for example, metal oxides and/or metal nitrides.

Finally, according to a variant, if decorative layer 31 is electrically conductive, decorations 23, 25, 27 may be electroplated after step 9, in order to thicken each portion including said decorative layer.

Upon reading the invention hereinbefore, it is thus clear that method 1 uses less material to form decorative layer 31 than the usual methods shown in FIGS. 1 and 2. Further, the problem of positioning portions 23, 25 and 27 is confined to the quality of performance of step 3.

Of course, this invention is not limited to the illustrated example but is capable of various variants and alterations that will appear to those skilled in the art. In particular, the body 22 may be made from a material different from a plastic material, such as, for example, a composite or ceramic material. Step 3 may also be achieved via a different method from the injection moulding presented hereinbefore, such as for example, calendering, thermoforming, compression moulding, stamping and/or drawing on a press.

Upon reading the invention hereinbefore, it is also clear that the flat surfaces of dial 21, in particular such as secondary display 29, may also be selectively coated with a decorative layer 31 to give an additional attractive effect. Suitable structuring need only be provided in step 5 for said coated portions of the flat surfaces of dial 21 to remain after step 9.

Finally, the shapes of hollows 34, 36 and/or bosses 33, 35 are not limited to the examples of FIGS. 10 and 12 but may, for example, be round, elliptical, rectangular or more generally polygonal.

1-14. (canceled)

15. A method for fabricating a part with relief, wherein said portions in relief are at least partially coated with a decorative layer, the method comprising:
a) forming the body of the part;
b) selectively altering the surface state of the body of the part in order to change the adherence thereof locally relative to said decorative layer;
c) directly depositing said decorative layer over the entire body ;
d) removing the portions of the deposited layer which have not adhered to the body of the part.

16. The method according to claim 15, wherein b) is for locally decreasing the adherence of the surface of the body so that, in c), the deposited layer does not adhere to the altered portions.

17. The method according to claim 16, wherein the decreased adherence is obtained by forming bosses alternating with hollows, the height and width of the hollows being comprised respectively between 50 and 200 mm and 5 and 20 mm, and the width of the bosses between 0.1 and 3 mm.

18. The method according to claim 15, wherein b) is for locally increasing the adherence of the surface of the body so that, in c), the deposited layer adheres to the altered portions.

19. The method according to claim 18, wherein the increased adherence is obtained by forming bosses alternating with hollows, the height and the width of the hollows being comprised respectively between 2 and 10 mm and 5 and 20 mm, and the width of the bosses between 5 and 20 mm.

20. The method according to claim 19, wherein the widths of the hollows and the bosses are substantially equal.

21. The method according to claim 15, wherein a) is achieved by injecting material into a mould.

22. The method according to claim 21, wherein a) and b) are performed at a same time by locally altering the internal surface state of said mold.

23. The method according to claim 15, wherein b) is performed by locally altering the surface state by laser radiation.

24. The method according to claim 15, wherein c) is performed by vapor phase deposition.

25. The method according to claim 15, wherein the decorative layer includes at least one metallic material.

26. The method according to claim 25, wherein, after d), galvanoplasty is performed in order to thicken each portion including said decorative layer.

27. The method according to claim 15, wherein the body of the part is made using a plastic material.

28. The method according to claim 15, wherein the part with relief is a timepiece dial.
